(19) United States
(12) Patent Application Publication
(10) Pub. No.: US 2013/0085956 A1
(43) Pub. Date: Apr. 4, 2013

(54) Method of Donating to a Charity via an Event Outcome

(71) Applicants: David T. Maloney, Houston, TX (US); Marc Hodulich, Atlanta, GA (US)

(72) Inventors: David T. Maloney, Houston, TX (US); Marc Hodulich, Atlanta, GA (US)

(21) Appl. No.: 13/613,267

(22) Filed: Sep. 13, 2012

Related U.S. Application Data
(60) Provisional application No. 61/541,887, filed on Sep. 30, 2011.

(51) Int. Cl. G06Q 99/00

(52) U.S. Cl. 705/329

(57) ABSTRACT

A system and method to facilitate donating to a charity with a donation level linked to the outcome of a specific event or series of events. Participants raising money for a charity log onto a website where they select a charity, an event and a performance based wager. A donor, planning to contribute to a charity, logs onto the same website, and selects a charity, an event and a participant, and agrees to participate in the wager proposed by the participant. The donor authorizes payment of the proposed wager to the charity dependent on the participant performance. Participants may be individuals, teams or individual members of a team. The charities may be any registered or recognized charity. The events may be any on which a quantifiable prediction may be made. Donors may be individuals, corporations, associations, partnerships, special interest groups or fan clubs.

### CLAIM OF PRIORITY

This application claims the priority of U.S. Ser. No. 61/541,887 filed on Sep. 30, 2011, the contents of which are fully incorporated herein by reference.

### FIELD OF THE INVENTION

The invention relates to an automated method of contributing to a charity, and more particularly, a method in which the value of the donation is linked to an outcome of a sporting event.

1. Background of the Invention

Charity donations related to sporting activities are a major business. In 2009, an estimated $1 billion was raised for US charities from participants in road races ranging from 5K events to marathons. And the process appears to be global. For instance, participants in the 2010 London marathon raised over $80 million for charitable causes.

The present invention relates to a system and method for extending this enthusiasm for combining individual sporting challenges to contributing to charities.

The present invention is intended to expand the range of events and ability contents that may serve as fundraising vehicles. By using Internet linked computing, including social media connections, the present invention also intends to increase the range of participants to also include other entities such as, but not limited to, teams, groups and members of teams and the network of people able to make charitable contributions to also include entities such as, but not limited to, individuals, companies, associations, fan clubs or some combination thereof.

2. Description of the Related Art

Relevant art involving charity contributions linked to sporting outcomes includes:

U.S. Pat. No. 6,902,480 issued on Jun. 7, 2005 to Adam E. Kidron entitled “Method and system for providing electronically placed wagers for another” that describes a method in which a wager is placed by a first user for a second user, through a wager server. The wager is composed from a selection of events and associated odds. The wager is tracked by the wager server. Once an outcome of the wager is determined, the wager server notifies the second user. If the outcome is positive, the second user is provided the winnings of the wager, while the first user receives no monetary reward from the wager.

US Patent Application Publication number US 2008/0081685 submitted by Shmargal Naftaly on Oct. 2, 2006 entitled “Online wagering method” that describes a method of online wagering on events such as sports, financial markets, politics, entertainment, and the like. The user is required to select an event and wager on the outcome of the selected event by entering a bid amount. The user also selects time period and day of the wager. Winners are determined based on the users' selections of the outcome of the event and the time and date of the wager. The total amount of money wagered by all the participants is proportionately distributed among the winners, after transactional fee deduction, according to the individual bid amounts entered by the winners.

US Patent Publication number US 2009/0024528 submitted on Jul. 25, 2008 by Ramon Otero entitled “Method and System for Charitable Fund Raising in Conjunction with Game of Chance Participation by Donors” that describes a method for making a contribution to a charitable organization through a financial transactions device by a participant having an account with a financial institution accessible through the financial transaction device. The method comprising: (a) the participant conducting a financial transaction at the financial transactions device, the financial transaction involving the financial institution; (b) the participant solicited to make a contribution to the charitable organization through the financial transactions device; (c) the participant making the contribution by deduction from the participant's account at the financial institution; (d) crediting the contribution to an account of the charitable organization; (e) soliciting the participant to participate in a game of chance through the financial transactions device; (f) the participant selecting a game entry object or automatically receiving the game entry object; (g) closing participation in the game of chance; (h) selecting a game winning object; (i) comparing the participant's game entry object with the game winning object; (j) declaring the participant to be a winner if there is a predetermined relationship between the game entry object and the game winning object; and (k) crediting a prize amount, if any, to the participant's account.

US Patent Publication number 2009/0327122 submitted on Mar. 25, 2009 by Assaf Isac entitled “Method and System for Facilitating Charitable Donations” that describes a system and method for facilitating charitable donations. A first possible outcome of a game is associated with a first charity, online wagers against the first possible outcome are accepted and in response to the first possible outcome actually occurring, all, or a portion, of the wagered sums are electronically credited to an account associated with the first charity.

Disclosed is a system and method for facilitating charitable donations. While various implementations are known in the art, they fail to address all of the problems solved by the invention described herein. One embodiment of this invention is illustrated in the accompanying drawings and will be described in more detail herein below.

### SUMMARY OF THE INVENTION

The present invention relates to a system and method to facilitate donating to a charity with a donation level linked to the outcome of a specific event or series of events.

In a preferred embodiment, one or more participants planning to raise money for a charity may log onto a website that may be running on a web server. The participant may select a charity, an event and a performance based wager, and those selections may then be recorded or published.

A donor, planning to contribute to a charity, may log onto the same website, or one that may be linked to it, and select a charity, an event and a participant, and agree to participate in the wager proposed by the participant. The donor may then authorize payment of the proposed wager to the charity dependent on the participant performance.

As discussed in more detail below, the participants may be entities such as, but not limited to, an individual, one or more teams, an individual member of a team, or some combination thereof.

The charities may, for instance, be any registered or otherwise licensed charity, or any suitable fundraising cause recognized by any appropriate taxing or regulating authorities.

The events may be any suitable event on which a quantifiable prediction may be made, including, but not limited to, individual sporting or ability events, team sporting or ability events, group sporting or ability events, or some combination thereof.

Donors may be any suitable entity such as, but not limited to, individuals, corporations, associations, partnerships, special interest groups, fan clubs, or some combination thereof.

Therefore, the present invention succeeds in conferring the following, and others not mentioned, desirable and useful benefits and objectives.

It is an object of the present invention to provide individuals and groups with a convenient means for fundraising.

It is another object of the present invention to provide participants with a range of betting models including an Under/Over wager model, Progressive donation model and a Reps-based donation model.

Yet another object of the present invention is to provide donors with a choice of charities to donate to and events and participants to wager on.

Still another object of the present invention is to provide secure, online commitments and settlements of wagers.

Still another object of the present invention is to allow participants to publicize their fundraising goals.

### BRIEF DESCRIPTION OF THE DRAWINGS

FIG. 1 shows a flow diagram of certain steps in the fundraising process as seen by a participant.

FIG. 2 shows a flow diagram of certain steps in the fundraising process as seen by a donor.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

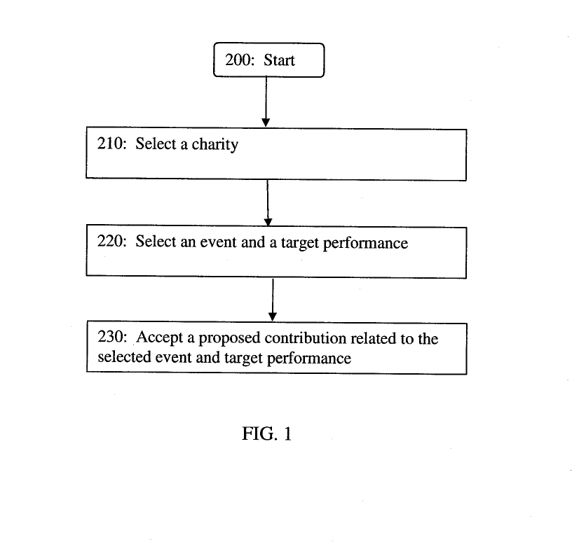

FIG. 1 shows a flow diagram of certain steps in the fundraising process of the present invention, as seen by a participant.

In step 200: Start; an entity wanting to make use of a website for fundraising as a participant in an event may, for instance, set up an account on the website. The participant may, for instance, be an entity such as, but not limited to, an individual, a team, an individual member of a team, a group or an individual member of a group or some combination thereof. The account may, for instance, be set up by a representative of the participating entity.

In step 210: Select a charity; the participating entity, or their representative, may elect a charity they want to support and to whom all, or a predefined percentage, of any of the rewards, or winnings, from the wager may be made available. The charity may, for instance, be any registered or otherwise licensed charity, or any suitable fundraising cause recognized by any appropriate taxing or regulating authorities.

In step 220: Select an event and a target performance; the participating entity, or their representative, may elect a suitable event to participate.

The events may be any suitable event on which a quantifiable prediction may be made, including, but not limited to, individual sporting or ability events, team sporting or ability events, group sporting or ability events, or some combination thereof.

The participant may also select a performance prediction, a type of wager to make and a fundraising goal.

The type of wager may include a donation bet such as, but not limited to, an Under/Over wager model, a Progressive donation model, a Reps-based donation model.

In step 230: Accept a proposed contribution related to the selected event and target performance; the participant may accept a proposed contribution or wager from a donor.

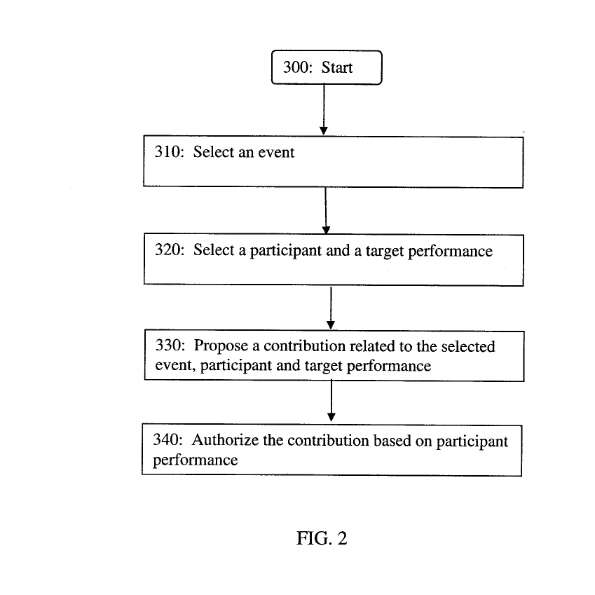

FIG. 2 shows a flow diagram of certain steps in the fundraising process as seen by a donor.

In step 300: Start; an entity wanting to make a charitable donation may connect to the fundraising website. The prospective donor may, for instance, be an entity such as, but not limited to, an individual, a group, a corporation, an association or some combination thereof. The prospective donor, or a representative of the entity, may log onto the website and create a donor account.

In step 310: Select an event; the prospective donor may select a type of event they would like see participants in.

In step 320: Select a participant and a target performance; the prospective donor may select a particular participant and review their target performance.

In step 330: Propose a contribution related to the selected event, participant and target performance; the donor may offer to take part in a wager with a particular participant.

In step 340: Authorize the contribution based on participant performance; the donor may provide a method for completing the wager. This may for instance take the form of authorizing payment from a funding source such as, but not limited to, an electronic online payment service, a credit card, a bank, an organization having a billing service or some combination thereof.

One of ordinary skill in the art will readily appreciate that the steps described above may be performed in various orders using various technologies.

For instance setting up an account may be accomplished in a variety of ways, such as, but not limited to, selecting a “Start Fundraising” button or icon, then choosing an athletic competition currently appearing on a roster of events that may appear as an alphabetized drop-down menu, or through a geography search done via a map, or from a choice of categories of events such as, but not limited to, running, triathlon, biathlon, cycling, swimming,

Well known forms may then be used to collect related information such as, but not limited to, name, email address, password, verification answers, or some combination thereof.

Similarly, selecting a charity may be done using well known technology that may be used to provide options such as, but not limited to, selecting a charity from a drop-down menu, selecting a category of charities and selecting a single charity within the chosen category, keying-in the name of a charity and, if available on the website, selecting it, or some combination thereof.

The types of betting may include, but is not limited to, the following formats.

An Over/Under donation. In this wager, a donor may submit a defined range, including a high and a low amount, of money that may be donated to a charity that may be a pre-determined charity. The “over” amount may represent the amount that may be donated if the competitor exceeds their stated performance goal and is typically larger than the “under” amount, that may represent the amount that may be donated if the competitor does not reach their performance goal. The donation is typically submitted prior to the event's commencement and the benefiting charity may be determined by the competitor. Typically, the donation may not be canceled by the donor once they have finalized the bet, through if the competitor is unable to compete in the competition, there may be a mechanism for cancelling all or part of the donation.

Progressive donation. In a progressive donation, a donor may opt to contribute an amount, typically defined prior to the event, that may increase or decrease in proportion to the competitor's performance relative to their predetermined performance goal.

There may, for instance, be a pre-defined sum that may only be donated if the competitor exactly meets the predetermined performance goal. The donated sum may, for instance, decrease to 0% of the pre-defined sum if the competitor fails to achieve a certain percentage of the performance goal, such as, but not limited to, 50% of the performance goal. There may also be a predefined limit on how much the pre-defined sum may be increased if the competitor exceeds their performance goal. The pre-defined sum may, for instance, never increase to greater than 200% regardless of the competitor's performance.

Reps-based donation. This option allows a donor to pledge a fixed amount that may increase based upon the quantity of repetitions successfully completed by a competitor.

The donation may, for instance, be facilitated using graphics such as, but not limited to, a bar graph that displays the per-unit amount and allows a donor to slide the bracket up from 0-100 allowing the quantity of repetitions and corresponding donation amount to appear on the user's screen.

1-on-1 Featured Bets. This is a bet in which one individual or team is competing against one other individual or team. The wager would typically be initiated by one of the parties involved in the competition who may suggest a wager to the other party. The two parties may then establish the nature of the contest, and they may also establish a baseline wager and the charity they want to benefit. Once the two parties have defined the parameters of the wager, any donor may then also participate. The donor may, for instance, choose which party it is wagering on to win and the amount of the wager. The donor typically may also agree that their wager will benefit the charity defined by the participating parties.

1-on-1 Undefined Featured Bets. In this method of donating there is one individual or team involved in a contest with one other individual or team.

In this bet, however, any individual donor may determine the opposing parties, and the opposing parties do not have to even be competing in the same event, though typically the opposing parties may be competing in the same calendar year or sports season.

The opposing parties typically do not authorize the proposed contest and, therefore, there may be no defined baseline donation. The contest may involve the teams or individuals actually opposing each other, and the contest may involve events such as, but not limited to, seasonal wins or conference wins, 1-on-1 match-ups, individual contests, team match-ups or some combination thereof. Once the contest and participating parties are selected by the same individual, they typically may not be altered. The benefitting charities may, for instance, be assigned on a bettor-by-bettor basis, or there may be a default charity associated with an individual, or team, that the bettor may choose to also support.

If there is an uneven quantity of bets, or an uneven dollar amount of bets, then the excess bets may be divided evenly across the winning donors' charities, and each donor may be recognized as having an equal share in the quantity donated.

Bettor vs. Bettor (defined) Featured Bets. This option allows random donors to define an event and bet on it. A first bettor may, for instance, define a contest as well as their wager and charity. A second bettor may agree to the challenge and wagered amount, and define their charity.

Although the invention has been described as a bettor or bettors making one bet at a time on one person, the same system could be modified to allow multiple bets from one access point. For instance, a bettor may bet on three different contestants for one charity by accessing the appropriate charity site and clicking on multiple names of contestants. Additionally, the bettor may be able to bet on one contestant in a number of different contests, for instance, choosing the contestant on a site and selecting contests from a scroll-down screen for that contestant. The contests could be for the benefit of the same charity or for different charities. Other permutations of multiple betting from the same site could be also be achieved.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of donating to a charity via an event outcome, comprising:
initiating, using a computer processor, a wager on behalf of a participant, said wager being contingent on a performance by said participant;
logging onto a data display page by a donor, said data display page being operatively connected to said computer processor and operative to display conditions of said wager;
participating in said wager by said donor by reporting via said display page to said computer processor, a sum of money to be wagered; and
wherein, on said wager being decided, a predetermined portion of said sum of money wagered is paid to a charity.

2. The method of claim 1 wherein said charity is selected by said participant.

3. The method of claim 1 wherein initiating a wager further includes said participant logging on to a webpage operatively connected to said computer.

4. The method of claim 1 wherein, if said wager is decided in favor of said participant, a predetermined portion of said sum of money wagered is paid to said charity.

5. The method of claim 1 wherein said charity is a tax-registered charity.

6. The method of claim 1 wherein said wager is an over-under wager.

7. The method of claim 1 wherein said wager is based on a predetermined prediction of a level of accomplishment in said performance.

8. The method of claim 7 wherein said prediction of a level of accomplishment is a number of repetitions of a particular activity.

9. The method of claim 1 wherein initiating said wager further includes selecting a sport in which said participant will perform.

10. The method of claim 9 wherein said sport is one of the group consisting of running, a triathlon, a biathlon, cycling, swimming, a hot dog eating contest, or a combination thereof.

11. The method of claim 1 wherein initiating said wager further includes selecting a geographic location in which said participant will perform.

12. The method of claim 1 wherein initiating said wager further includes selecting a particular event in which to participate.

13. The method of claim 1 wherein initiating said wager further includes setting a fundraising goal.

14. The method of claim 6 wherein said under/over wager further comprises said donor setting a predetermined lower amount to be paid to said charity if said participant fails to achieve a predetermined level of performance, and a predetermined upper amount to be paid to said charity if said participant accomplishes said predetermined level of performance.

15. The method of claim 7 wherein said wager is a progressive wager based on said predetermined level of performance and wherein said donor sets a target amount to be paid to said charity if said participant exactly meets said predetermined level of performance, and agrees to pay a lesser amount than said target amount if said participant fails to meet said predetermined level of performance, said lesser amount being proportional to how far said participant is short of reaching said predetermined level of performance.

16. The method of claim 15 further comprising said donor agreeing to pay a larger amount than said target amount to said charity if said participant exceeds said predetermined level of performance, said larger amount being proportional to how far said participant exceeds said predetermined level of performance.

17. The method of claim 16 wherein said lesser amount is 0 if said participant achieves 50% or less of said predetermined level of performance, and wherein said larger amount is limited to 200% of said target amount regardless of by how far said participant exceeds said predetermined level of performance.

18. The method of claim 1 wherein initiating said wager further comprises said wager being initiated jointly on behalf of said participant and on behalf of a second participant, and wherein said performance by said participant further includes a result of a competition between said participant and said second participant.

19. The method of claim 18 wherein initiating said wager further includes said participant selecting a charity, and said second participant selecting a second charity, and wherein if said wager is decided in favor of said participant, said second participant pays a predetermined sum of money to said charity, and if said wager is decided in favor of said second participant, said participant pays said predetermined sum of money to said second charity, and wherein said donor agrees to pay said sum of money wagered by said donor to whichever of said charities is paid by said participants.

20. The method of claim 19 wherein each of said participants is a team or a member of a team, and wherein a donor may duplicate all or part of said participants bet.
